(19) United States
(12) Patent Application Publication
(10) Pub. No.: US 2010/0031227 A1
(43) Pub. Date: Feb. 4, 2010

(54) Structured Representation of Integration Scenarios of Software Products

(75) Inventor: John A. Cook, Austin, TX (US)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/184,813

(22) Filed: Aug. 1, 2008

(51) Int. Cl. G06Q 10/00; G06F 9/44

(52) U.S. Cl. 717/102

(57) ABSTRACT

Providing a structured representation of integration scenarios of software products. Specifically, the invention provides methods and systems for modeling the conceptual entities that a software developer encounters when modeling software products and the people that use the software products.

### FIELD OF THE INVENTION

The present disclosure relates generally to the field of software development, and more particularly to systems and methods for providing a structured representation of integration scenarios of software products.

### BACKGROUND

Software developers face many challenges when designing software products for end users. The software developers may try to model the end users by gathering information obtained through research or from past experience. Within a software company, each software developer may already have information on users that they have modeled in the past. This information may be useful to other software developers within the software company that are trying to model end users that perform similar tasks or have similar skill sets. Without a system to store and allow access to this information, it can be difficult for this information to be shared.

What is needed are systems and methods to enable software developers to contribute information about their software products and product users and for other software developers to be able to access this information.

### SUMMARY

The present invention provides systems and methods for providing a structured representation of integration scenarios of software products.

An aspect of the present invention provides a system for structured representation of integration scenarios of software products. This system includes software customer design elements where each software customer design element includes information describing one or more software products and a relationship with one or more customer design elements; user customer design elements where each user customer design element includes information describing one or more users of the software products and a relationship with one or more customer design elements; a plurality of relationship elements wherein each relationship element defines a relationship between two or more customer design elements; a database for storing software customer design elements and for storing user customer design elements; a software editor to edit software customer design elements and to edit user customer design elements; a search tool for searching the database for software customer design elements and for searching the database for user customer design elements; an analysis tool for analyzing software customer design elements and analyzing user customer design elements and creating reports based on the analysis; a publisher program for publishing software customer design elements and for publishing user customer design elements into one or more software formats; and a repository for storing published software customer design elements and for storing published user customer design elements and for allowing access to published software customer design elements and published user customer design elements.

### BRIEF DESCRIPTION OF THE DRAWINGS

FIG. 1 depicts an operating environment in accordance with an exemplary embodiment of the present invention.

FIG. 2 provides a flow diagram for structured representation of integration scenarios of software products in accordance with an exemplary embodiment of the present invention.

### DETAILED DESCRIPTION OF EXEMPLARY EMBODIMENTS

The present invention provides systems and methods for providing a structured representation of integration scenarios of software products. Specifically, the invention provides methods and systems for modeling the conceptual entities that a software developer encounters when modeling software products and the people that use the software products.

Turning now to the drawings, in which like numerals indicate like elements throughout the figures, exemplary embodiments of the invention are described in detail.

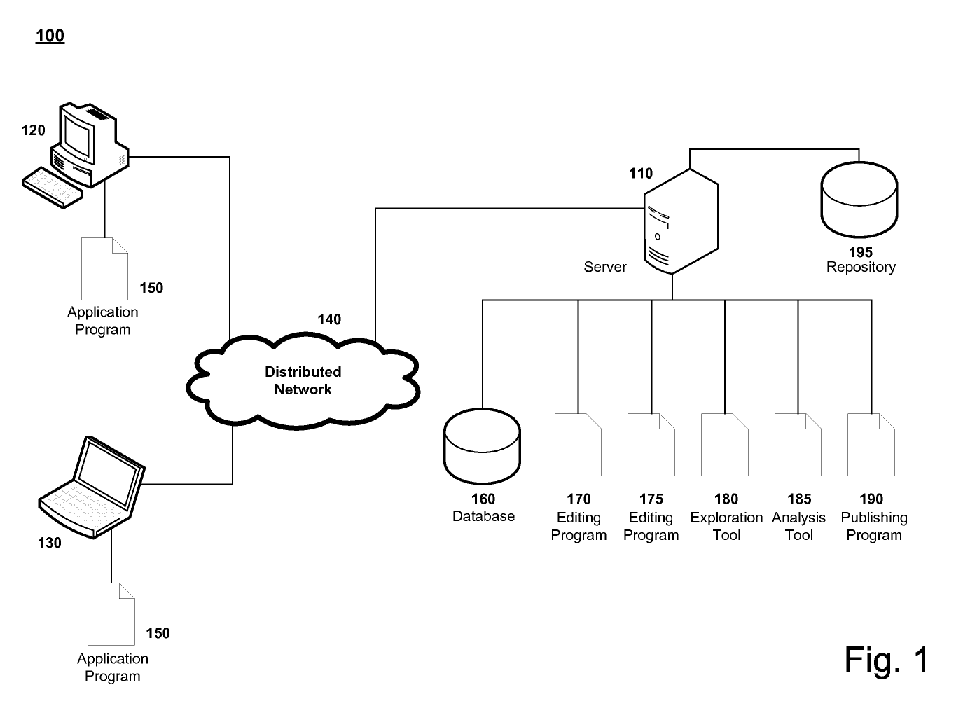

FIG. 1 depicts an operating environment 100 in accordance with an exemplary embodiment of the present invention. Referring to FIG. 1, a server 110 is connected to a distributed network 140, such as a local area network (LAN). The distributed network 140 could also be a private wide area network (WAN), the Internet, or some other network and is not limited to a LAN.

Connected to the server 110 through the distributed network 140 are client devices, such as a personal computer 120, and a laptop computer 130. Of course, any number of client devices may be connected to the server 110 through the distributed network 140. These client devices may include more personal computers (not shown), more laptop computers (not shown), or other mobile devices (not shown).

The server 110 may contain one or more databases that store customer design elements and other work products, such as database 160. The server 110 may also contain one or more application programs that allow users to create, access, revise, delete, and publish customer design elements and work products stored in the database 160, such as application programs 170, 175, 180, 185, and 190.

Customer design elements are elements that contain information about software products and the people that use the software products. In the exemplary embodiment discussed in reference to FIG. 1, the customer design elements are stored in Extensible Markup Language (XML) documents.

There can be many types of customer design elements, including “atomic” customer design elements, “composed” customer design elements, “collection” topic elements, and “relationship” customer design elements. Composed customer design elements typically have more associations with other elements, including other atomic elements other composed elements. Atomic elements are typically fine grain elements such as a skill, a goal measure, a tool, or a responsibility that are referenced by the composed customer design elements. Each customer design element can include a title, a description, and associations to other customer design elements.

In one exemplary embodiment, two primary composed elements can be a “role” and a “persona.” A role element is a customer design element that contains a set of responsibilities and skills that may model a software user, such as an IT operator role. Each responsibility and skill of a role are also customer design elements that may be a part of many different role elements. An example responsibility element is to perform diagnostic tests. This responsibility may also be a part of a network administrator role. An example skill element is the ability to run diagnostics. A role is not limited to responsibility and skill elements. A role can contain other customer design elements as needed to model the software user.

A persona element is a customer design element that describes an example person representative of the roles that typical users assume. A persona may be defined by responsibility and role elements, plus goal, skill, motivation, emotion, and behavior elements. This data may be discovered through many resources including user research. The persona elements help designers understand and focus on characteristics of users that are important to the design.

Some examples of secondary customer design elements are goal, task, use case, and scenario elements. A goal element may be used to describe a result to be achieved related to the design of a software offering independent of how the goal is achieved. A task element may be used to describe a step performed to reach a goal. Scenario elements may be used to describe paths through a task flow for a given task role or persona that have a structure similar to the structure of tasks. One type of scenario element may be a high level flow through technology and product agnostic steps to perform a task. Another type of scenario element may be a detailed flow through technology and product agnostic steps for performing one or more typical tasks. Use case elements may be used to describe a function that a system performs to achieve the user's goals. Each use case element may describe a particular goal for the user and how the user interacts with the system to achieve that goal.

Some examples of atomic customer design elements are measure, responsibility, skill, pain point, tool, and object elements. A measure element may be used to describe a quantitative, Boolean, or categorized value which can be observed within a facet of the domain of study. A responsibility element may be used to describe an obligation of a role or of a persona for which the role or persona can be held accountable. A skill element may be used to describe a learned or developed power or aptitude of doing something competently. A pain point element may be used to describe something that annoys or prevents a role or a persona from achieving its goals. A tool element may be used to describe a product or a category of product. An object element may be used to represent the concepts and entities users perceive in order to perform a task.

Collection topic elements are used to organize customer design elements into groups. Some examples of collection topic elements are role discipline, role domain, and task group elements. A role discipline element may be used to hold a set of roles and to describe the relationship between the roles in the set. A role domain element may be used to group a set of role disciplines. A task group element may be used to hold a set of tasks and to describe the relationship between the tasks in the set.

Another group of customer design elements that may be used are relationship elements. Relationship elements are used to define named relationships between an owning topic customer design element and a set of other elements. For example, a “hasmeasures” relationship element may be used to represent that a set of measures are related to a goal. The set of measure elements that are related to that goal element would be listed in the goal element with a hasmeasures reference to the measure elements.

The above mentioned customer design elements serve as examples of customer design elements and does not represent an exhaustive list of customer design elements. An exemplary embodiment of the present invention is an extension of the Darwin Information Typing Architecture (DITA), which is used to represent topic based information. Many of the existing DITA topics may be used in combination with the customer design elements listed above.

The database 160 provides persistent storage of customer design elements and related work products, including transformed instances of the XML data representing these elements. New customer design elements and work products may be placed into the database 160. Existing customer design elements and work products may be deleted from, renamed, or modified in the database 160.

The server 110 contains an application program 170 that is capable of editing atomic customer design elements. For XML based systems, the application program 170 may be a simple text editor or a more advanced XML editor. A user may access the application program 170 at the server 110. Users may use application program 170 to create customer design elements from scratch, from copying and then modifying existing customer design elements, or from templates. For example, a user may want to define a new responsibility element for reviewing diagnostic tests. Since the new responsibility is similar to an existing responsibility, perform diagnostic tests, the user could copy this responsibility and modify the copy to meet the requirements of the new responsibility, review diagnostic tests.

The server also contains an application program 175 that is capable of editing composed customer design elements. The application program 175 can be accessed at the server 110. In one exemplary embodiment, the application program 175 is capable of using contributions from XML files, atomic customer design elements, and composed customer design elements to produce new composed customer design elements with accurate references to other customer design elements. For example, if a user wants to create a new role element, the user could use the application program 175 to select an existing role element and to select additional customer design elements that are needed in the new role such as an additional responsibility element and one or more additional goal elements. The application program 175 could then create a new role containing the customer design elements of the existing role and the additional customer design elements selected.

The atomic customer design element editor 170 could also be used to edit composed customer design element. Thus, new composed elements can be created from scratch, from copying and then modifying existing composed customer design elements, or from templates.

The server 100 contains a customer design element exploration tool 180. The customer design exploration tool 180 is capable of performing queries or searches on the content of the database 160, gathering a result set holding the selected customer design elements, and returning the results set. The customer design exploration tool 180 is also capable of maintaining a selection set of customer design elements held in the database 160 and updates the selection set when the user of the customer design exploration tool 180 modifies the selection. The customer design exploration tool 180 also enables the creation of selection sets of customer design elements from the database which can then be used by other tools, such as a customer design analysis tool 185.

The customer design analysis tool 185 is capable of comparing selected attributes or highlighting selected content elements or selected associations of customer design elements. The customer design analysis tool 185 can operate from the selections sets provided by the customer design exploration tool 180. The output from the customer design analysis tool 185 can include “canned” reports on the selected customer design elements and a more visual comparison on a new custom diagramming surface. For example, a user may be planning to develop a new software program that is going to be used by IT Analysts. The user could use the application program 180 to search for relevant customer design elements, such as role elements similar to an IT Analyst and responsibilities similar to those of an IT Analyst. After searching for the relevant customer design elements, the user could use the customer design analysis tool 185 to print a canned report for each of the elements contained in the search results.

The server 110 contains an application program 190 that is capable of publishing customer design elements that are stored in the database 160 in one or more formats, such as HyperText Markup Language (HTML), Adobe Portable Document Format (PDF), and XML. The published customer design elements can be stored in a database, such as a depository 195. When published to the repository 195, related customer design elements that form a composed element, such as a role, can all be placed into one XML file. This single file allows for easier tracking and downloading, and it may provide a more useful format to use when modifying and creating new customer design element content.

Users can access the published customer design elements stored in the repository 195 using an application program 150 executing on a client device 120 or 130 which is connected to the server 110 through the distributed network 140. The application program 150 may have a user interface that allows the user to search the repository 195 for published customer design elements and work products. For example, if the published reports are in XML or HTML format, a web browser may server as the application program 150.

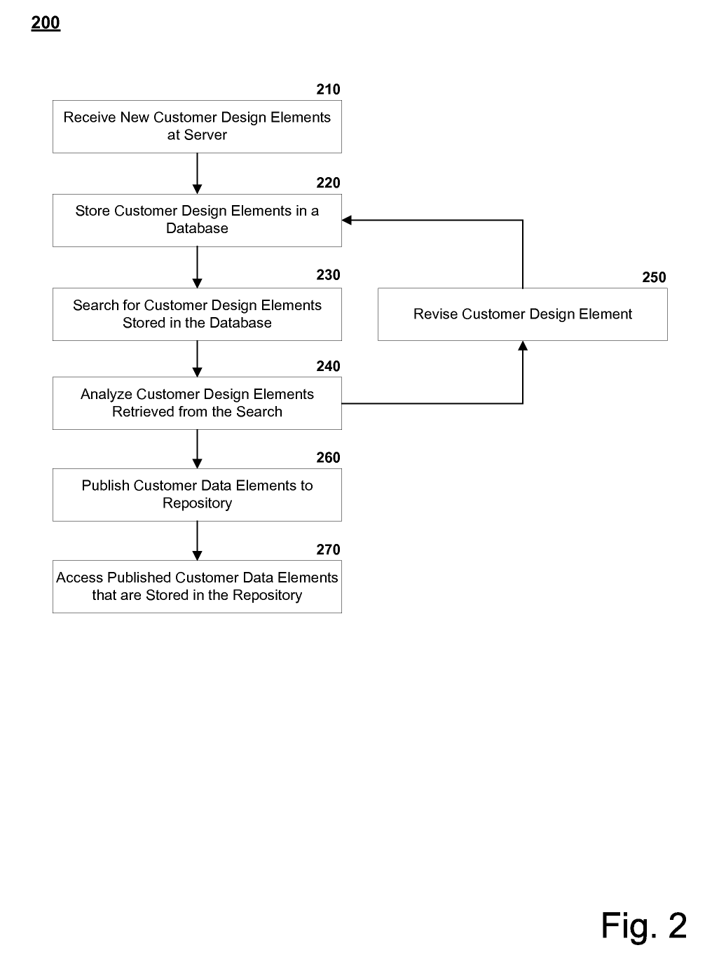

FIG. 2 provides a flow diagram 200 for structured representation of integration scenarios of software products in accordance with an exemplary embodiment of the present invention. Referring to FIGS. 1 and 2, at step 210, a user creates new atomic and composed customer design elements using application program 170 executing on the server 110. When the server receives the new customer design elements, at step 220, the server stores the customer design elements in the database 160. For example, a user may create a new role customer design element to model an IT Analyst. The user may also create other atomic and composed customer design elements to help model the IT Analyst role, such as a “Plan System Architecture” responsibility element and a set of skill elements that would represent skills need to perform the responsibility elements.

At step 230, a user searches for existing customer design elements stored in the database 160 using a customer design exploration tool 180. For example, a user may want to search for persona elements that model a person that might use the software that that user is developing. The user could search for personas matching a list of customer design elements, such as responsibility elements and skill elements.

At step 240, a user creates reports based on the search results of step 230 using a customer design analysis tool 185. For example, the user may want to print reports detailing the matching personas. An aspect of the report may contain a listing of pain point elements that prevent the matching persona elements from completing their tasks. The user could then develop software that eliminates the reported pain point elements.

Optionally, a user can revise existing customer design elements at step 250 using application program 170 or 175. For example, a user can expand the relationship of a persona by adding a new pain point to that persona. Or, a user could create a new customer design element using existing customer design elements. For example, a user could use application program 175 to select an existing persona element and select additional customer design elements that are needed in the new persona such as an emotion element. After revising the customer design element, the revised customer design element is stored in the database 160 at step 220.

At step 260, a user publishes customer design elements to a repository 195 using application program 190. For example, the user may publish the customer design elements stored in the database 160 in HTML format for other software developers to view from a personal computer 120.

At step 270, a user accesses the published customer design elements in the repository 195 using the application program 150. If the customer design elements were published in HTML format, the user could use a web browser to access the published customer design elements.

One of ordinary skill in the art would appreciate that the present provides systems and methods for providing a structured representation of integration scenarios of software products. Specifically, the invention provides methods and systems for modeling the conceptual entities that a software developer encounters when modeling software products and the people that use the software products.

1. A system for structured representation of integration scenarios of software products, comprising:
a computer comprising computer program code and a processor that executes the computer program code;
a plurality of software customer design elements wherein each software customer design element comprises information describing one or more software products and a relationship with one or more customer design elements;
a plurality of user customer design elements for modeling users of the software products, wherein each user customer design element comprises information describing one or more users of the software products and a relationship with one or more customer design elements;
a plurality of relationship elements wherein each relationship element defines a relationship between two or more customer design elements;
a database, stored on the computer, for storing the plurality of software customer design elements and for storing the plurality of user customer design elements;
a software editor, executed by the computer, to edit the plurality of software customer design elements and to edit the plurality of user customer design elements;
a search tool, executed by the computer, for searching the database for the plurality of software customer design elements and for searching the database for the plurality of user customer design elements;
an analysis tool, executed by the computer, for analyzing the plurality of software customer design elements and analyzing the plurality of user customer design elements and creating reports based on the analysis;
a publisher program, executed by the computer, for publishing the plurality of software customer design elements and for publishing the plurality of user customer design elements into one or more software formats; and
a repository, coupled to the computer, for storing a plurality of published software customer design elements and for storing a plurality of published user customer design elements and for allowing access to the plurality of published software customer design elements and the plurality of published user customer design elements,
wherein each user customer design element comprises a role element comprising a set of responsibilities and skills that model a user of the software product or a persona element describing an example person representative of roles the user assumes.
